(19) United States
(12) Patent Application Publication
(10) Pub. No.: US 2026/0341116 A1
(43) Pub. Date: Oct. 29, 2026

(54) SYSTEMS AND METHODS OF ELECTRONIC GAMING INCLUDING A DOUBLE FEATURE TRIGGER

(71) Applicant: Aristocrat Technologies, Inc., Las Vegas, NV (US)

(72) Inventors: Zachary Cooper, Reno, NV (US); Shailesh Kumpawat, Gurugram (IN); Daniel Marston, Reno, NV (US); Jeffrey Uss, Liberty Hill, TX (US); Kevin Walcomb, Reno, NV (US); David Marsh, Charlottesville, VA (US); Gwen Vulich, Reno, NV (US)

(21) Appl. No.: 19/187,656

(22) Filed: Apr. 23, 2025

(51) Int. Cl. G07F 17/32; G07F 17/34

(52) U.S. Cl. CPC G07F 17/3267; G07F 17/34

(57) ABSTRACT

An electronic gaming system including a processor and a memory is described. The processor is configured to determine a plurality of credit amounts and perform a first lookup in a first lookup table to determine whether a greatest credit amount of the plurality of credit amounts corresponds to a first feature amount stored in the first lookup table. The processor is also configured to cause the at least one processor to perform a second lookup in a second lookup table to determine whether a subset of the plurality of credit amounts correspond to a number of second feature amounts stored in the second lookup table. The processor is further configured to cause the plurality of credit amounts to be presented via display of at least the first feature content and the second feature content.

### TECHNICAL FIELD

The field of disclosure relates generally to electronic gaming, and more specifically, to systems and methods of electronic gaming including a double feature trigger.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

In one aspect, an electronic gaming device is described. The electronic gaming device includes at least one memory with instructions stored thereon and at least one processor in communication with the at least one memory. The instructions, when executed by the at least one processor, cause the at least one processor to determine a plurality of credit amounts associated with a play of an electronic game and perform a first lookup in a first lookup table of a plurality of lookup tables in the at least one memory to determine whether a greatest credit amount of the plurality of credit amounts corresponds to a first feature amount stored in the first lookup table wherein the first lookup table is associated with first feature content. The instructions also cause the at least one processor to perform a second lookup in a second lookup table of the plurality of lookup tables in the at least one memory to determine whether a subset of the plurality of credit amounts different from the greatest credit amount correspond to a number of second feature amounts stored in the second lookup table wherein the second lookup table is associated with second feature content. The instructions further cause the at least one processor to, based upon the greatest credit amount corresponding to the first feature amount stored in the first lookup table and the subset of the plurality of credit amounts different from the greatest credit amount corresponding to the number of second feature amounts stored in the second lookup table, cause the plurality of credit amounts to be presented via display of at least the first feature content and the second feature content.

In another aspect, at least one non-transitory computer-readable storage medium with instructions stored thereon is described. The instructions, in response to execution by at least one processor, cause the at least one processor to determine a plurality of credit amounts associated with a play of an electronic game and perform a first lookup in a first lookup table of a plurality of lookup tables in the at least one non-transitory computer-readable storage medium to determine whether a greatest credit amount of the plurality of credit amounts corresponds to a first feature amount stored in the first lookup table wherein the first lookup table is associated with first feature content. The instructions also cause the at least one processor to perform a second lookup in a second lookup table of the plurality of lookup tables in the at least one non-transitory computer-readable storage medium to determine whether a subset of the plurality of credit amounts different from the greatest credit amount correspond to a number of second feature amounts stored in the second lookup table wherein the second lookup table is associated with second feature content and, based upon the greatest credit amount corresponding to the first feature amount stored in the first lookup table and the subset of the plurality of credit amounts different from the greatest credit amount corresponding to the number of second feature amounts stored in the second lookup table, cause the plurality of credit amounts to be presented via display of at least the first feature content and the second feature content.

In another aspect, a method of electronic gaming implemented by at least one processor in communication with at least one memory is described. The method includes determining a plurality of credit amounts associated with a play of an electronic game and performing a first lookup in a first lookup table of a plurality of lookup tables in the at least one memory to determine whether a greatest credit amount of the plurality of credit amounts corresponds to a first feature amount stored in the first lookup table wherein the first lookup table is associated with first feature content. The method also includes performing a second lookup in a second lookup table of the plurality of lookup tables in the at least one memory to determine whether a subset of the plurality of credit amounts different from the greatest credit amount correspond to a number of second feature amounts stored in the second lookup table wherein the second lookup table is associated with second feature content and, based upon the greatest credit amount corresponding to the first feature amount stored in the first lookup table and the subset of the plurality of credit amounts different from the greatest credit amount corresponding to the number of second feature amounts stored in the second lookup table, causing the plurality of credit amounts to be presented via display of at least the first feature content and the second feature content.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 illustrates an example screenshot and/or interface of a base game, in accordance with the present disclosure.

FIG. 5 illustrates another example screenshot and/or interface of the base game shown in FIG. 4.

FIG. 6 illustrates an example screenshot and/or interface of a feature game, in accordance with the present disclosure.

FIG. 7 illustrates another example screenshot and/or interface of the feature game shown in FIG. 6.

FIG. 8 illustrates another example screenshot and/or interface of the feature game shown in FIG. 6.

FIG. 9 illustrates another example screenshot and/or interface of the feature game shown in FIG. 6.

FIG. 10 illustrates an example screenshot and/or interface of another feature game, in accordance with the present disclosure.

FIG. 11 illustrates another example screenshot and/or interface of the feature game shown in FIG. 10.

FIG. 12 illustrates another example screenshot and/or interface of the feature game shown in FIG. 10.

FIG. 13 illustrates another example screenshot and/or interface of the feature game shown in FIG. 10.

FIG. 14 illustrates another example screenshot and/or interface of the feature game shown in FIG. 10.

FIG. 15 illustrates another example screenshot and/or interface of the feature game shown in FIG. 10.

FIG. 16 illustrates another example screenshot and/or interface of the feature game shown in FIG. 10.

FIG. 17 illustrates another example screenshot and/or interface of the feature game shown in FIG. 10.

FIG. 18 illustrates another example screenshot and/or interface of the feature game shown in FIG. 10.

FIG. 19 illustrates another example screenshot and/or interface of the base game shown in FIG. 4.

FIG. 20 illustrates an example method of electronic gaming including a double feature trigger, in accordance with the present disclosure.

### DETAILED DESCRIPTION

Described herein are systems and methods of electronic gaming including a double feature trigger. In the example embodiment, multiple bingo patterns may be achieved (e.g., hit, or satisfied) for a play of an electronic game (e.g., based on a bingo card and a ball call). When multiple bingo patterns are achieved, a lookup occurs in memory to determine whether output amounts associated with those bingo patterns correspond to a double feature trigger (e.g., or single feature trigger, or no feature trigger), as explained in more detail herein.

If the output amounts do correspond to the double feature trigger, the double feature is triggered. In the example embodiment, the lowest output amount of the output amounts associated with the achieved bingo patterns is provided as a base game outcome including at least two trigger symbols (e.g., at least one for each feature), a highest output amount of the output amounts associated with the achieved bingo patterns is provided as a wheel multiplier feature game outcome, and output amounts of the output amounts associated with the achieved bingo patterns in between the lowest output amount and the highest output amount are provided (e.g., in ascending order) as outcomes for a free spin feature (e.g., super red screen feature spins, as explained elsewhere herein) in between the base game outcome and the wheel multiplier feature game outcome.

As an example, say the output amounts associated with the achieved bingo patterns correspond to the double feature trigger and are 10, 25, 100, 450, 800, 1000, and 5000. Presentation of the output amounts would be provided with 10 credits as a base game outcome including at least two trigger symbols (e.g., to communicate that the double feature has been triggered), 25, 100, 450, 800, and 1000 credits would be provided as outcomes for respective spins in a free spin feature, and 5000 credits would be provided as an outcome for a wheel multiplier feature.

The technical problems addressed herein include at least one of: (i) inability of known systems to provide multiple features associated with metamorphics (e.g., in Class II games); (ii) inability of known systems to search a plurality of lookup tables to determine possible ways to present game outcomes including via a double metamorphic feature; (iii) inability of known systems to dynamically build presentations in real time and/or near real time in order to provide a double metamorphic feature; and/or (iv) known systems providing Class II games in a computer inefficient manner that requires a burdensome amount of computer resources.

The resulting technical effects and/or technical benefits achieved by this disclosure include at least one of: (i) ability to provide multiple features associated with metamorphics (e.g., in Class II games); (ii) ability to search a plurality of lookup tables to determine possible ways to present game outcomes including via a double metamorphic feature; (iii) ability to dynamically build presentations in real time and/or near real time in order to provide a double metamorphic feature; (iv) ability to provide Class II games in a computer efficient manner that saves computer resources and improves computer efficiency (e.g., based upon the various lookups and/or dynamic building of presentations described herein); (v) displaying large quantities of complex information in a relatively small display area; (vi) communicating complex information with easy-to-understand animations on a display; (vii) efficiently communicating different game rules on a display during game play; and/or (ix) providing versatility as to which devices (e.g., EGMs, mobile devices, etc.) the games described herein may be played on because of the efficient display area designs described herein.

Various interface improvements are provided herein to efficiently and effectively communicate information. For instance, during play of a base game as described herein, multiple metamorphics may be displayed that communicate to a player when a certain feature has been triggered and/or an amount of time since a certain feature has been triggered. Once a feature has been triggered, the metamorphic associated with that feature may be animated (e.g., as a safe unlocking) to communicate that the feature has been triggered. During certain features (e.g., free spin feature), the color on the screen (e.g., a red tint) may change to communicate that the feature has been triggered. As another example, when a wheel multiplier feature has been triggered, a credit wheel may be displayed, and after the credit wheel spins, a multiplier wheel may be displayed as being animated and transitioning to replace display of the credit wheel in order for a multiplier wheel spin to be performed.

Example embodiments described herein may be provided in combination or in isolation to summarize and present game mechanics in a manner that improves the efficiency of computer systems (e.g., electronic gaming systems including electronic gaming devices). Each example system provides an improved user interface displaying a limited set of information to players, potentially within a small screen, such that players can more quickly understand the current status of the game. The systems and methods provide improved display device functionality (e.g., on a gaming device) by providing multiple visual indicators that communicate game mechanics described herein to players. The systems and methods provided herein also improve display and device efficiency by eliminating the need for complex information pages describing game mechanics to players. Because of at least the easily-understood animations, symbols, and indicators displayed, the games described herein can be played and understood on a single screen substantially smaller than some of the EGMs described herein (e.g., a mobile device such as a cell phone), thus removing the need for multiple displays with complex information screens including lengthy text.

By dynamically generating presentations (e.g., facades) to communicate a game outcome based upon real time and/or near real time lookups in a plurality of lookup tables (e.g., as explained herein), computer efficiency is increased and computer resources are saved at least because each unique entire presentation (e.g., combination of different outcomes for the base game, the free spin game, and/or the wheel multiplier game, etc.) does not need to be stored separately, as is done in some known systems. In other words, by the present system dynamically building presentations piece by piece for each total game outcome, instead of storing all possible entire presentations/sequences separately, computer memory is saved and computer efficiency is increased.

In the example embodiment, the electronic game described herein is a Class II bingo game presented on a gaming device. A bingo card and a bingo number listing may be displayed. For instance, a bingo card may include a matrix of bingo cells (e.g., squares). In some examples, the matrix may be a 5 x 5 matrix of 25 total cells. In some examples, the bingo card may have a matrix of a different size (e.g., 3 x 3, 4 x 4, 4 x 5, 4 x 6, 6 x 6, 7 x 7, 3 x 8, 10 x 10, etc.). In some examples, the matrix may be larger or smaller.

In some examples, the bingo game may be a networked game that involves two or more networked devices, such as gaming devices 104A-104X. For example, many electronic bingo games may be required, by state gaming regulations and/or bingo game rules, to include at least two players. As a result, in these circumstances, a bingo game can only occur if two or more players have placed wagers and received a bingo card to be used to determine a game outcome against a common ball call. A ball call may be initiated once at least two players have joined an electronic bingo game (e.g., a networked electronic bingo game), and each player’s bingo card (or cards) are compared to the same ball call, even where the players are physically separated, such as in different parts of a casino or even in different casinos/external locations.

A central determination gaming system server may manage (and/or host) the bingo game, such as by generating bingo cards (or cards, as above) and/or bingo number listings. In some examples, a bingo card (and/or information on which the bingo card is based), and/or the bingo number listing may be generated using an RNG (e.g., RNG 318). In some examples, the bingo card may be randomly selected from a set of bingo cards or a player may select their own bingo card (e.g., via a user interface), such as from a set of randomly generated bingo cards, for example.

In operation, a player and/or gaming device may be provided with a respective bingo card, such as by central determination gaming system server 106. For example, a player may be provided a new bingo card each time a "Spin" or "Play" button is pressed by the player (e.g., via a user interface), provided the player has made a wager/input. In some examples, more than one bingo card may be generated in response to a wager. A bingo number listing (e.g., “ball call”) may be randomly generated, such as by central determination gaming system server 106. A bingo card may be compared to the bingo number listing, and the numbered cells on the bingo card that match numbers in the bingo number listing may be marked or "daubed" on the bingo card. Finally, the marked or daubed bingo card may be evaluated against a paytable of winning bingo patterns.

The bingo number listing may be continually generated until a maximum amount of numbers are listed (e.g., seventy-five numbers listed) or until a game-ending pattern is awarded to a player participating in the bingo game. A typical game-ending pattern may be a bingo card blackout pattern, in which each of the numbers of a bingo card match a number displayed in the bingo number listing. Other game-ending patterns are also possible. When the game-ending pattern is awarded, the bingo number listing is reset, for all players participating in the bingo game and the process repeats. In some examples, a single play of the bingo game includes a wager, a bingo card, a bingo number listing, a matching of the numbers called with those on a bingo card, a determination of a bingo game outcome, and a presentation of an associated award, if any.

A bingo game outcome may be determined by comparing one or more patterns of marked (and/or “daubed”) cells of a bingo card with a paytable of winning bingo patterns. If the bingo card does not include a pattern that matches a pattern in the paytable of winning patterns, then a losing bingo outcome is determined, and no award may be provided to the player. If the bingo card does include a pattern that matches a pattern in the paytable of winning patterns, then a winning bingo outcome is determined, and a reward may be provided to the player.

Different winning patterns may be associated with different awards. The award for a winning main bingo game outcome may be based on an amount wagered, an associated main bingo game paytable, an associated set of rules for the main bingo game, a probability (and/or likelihood) of achieving a particular bingo pattern/combination, an amount of bingo numbers needed to achieve the particular bingo pattern/combination, and/or other considerations.

In some examples, the player may be awarded for only the highest priority pattern (e.g., the highest paying winning pattern) that is matched. In some examples, during play of a Class II game, a player is provided or selects a single bingo card for multiple plays of the bingo game, with a new bingo number listing generated for each play of the bingo game. Other methods of play of a Class II bingo game, Class III games, and/or other games are also envisioned and are within the scope of this disclosure.

In the example embodiment described herein, the player may be awarded for multiple patterns (e.g., all winning patterns) that are matched when the bingo card is evaluated against the paytable of winning patterns. For instance, each bingo pattern pay (e.g., each achieved bingo pattern that matches a pattern in a paytable) may be provided during different spins and/or types of games. In the example embodiment, bingo pattern pays are provided as part of a double feature wherein a base game is provided, a free spin feature is provided, and a wheel spin feature is provided (e.g., and/or other combinations thereof and/or other feature games).

For instance, bingo game outcomes may be presented to the player via a base game including a spinning reel game simulation. One or more combinations of symbols in a matrix of symbols may be associated with a reel game outcome that is equal to a bingo pattern pay. For example, a winning bingo game outcome may be displayed as a winning combination on reels. Similarly, a losing bingo game outcome (e.g., no bingo pattern pays) may be displayed as a losing combination on reels. Different outcomes of the bingo game may be displayed as different outcomes in the spinning reel game. Thus, the bingo game outcome is presented to the player at least in part as a particular reel spin outcome of reels.

In the example embodiment, winning bingo patterns may be displayed as a combination of game outcomes (e.g., for the base game, free spin game, wheel multiplier game, and/or any other games). In some embodiments, a total bingo game outcome may be determined (e.g., including one or more bingo pattern pays), followed by determination of a script of base game display patterns/sequences, free spin display patterns/sequences, and/or wheel multiplier display patterns/sequences that, in total, correspond to the determined game outcome (e.g., sequential display of the patterns/sequences results in the desired game outcome being displayed/provided – in some embodiments, patterns/sequences of the script may be arranged/organized in an order from a lowest value to a highest value).

In some examples, progressively increasing outputs may be applied in the Class II game as described herein. Game outputs (e.g., credit outputs) may be presented/paid from lowest to highest across a plurality of spins and/or a plurality of different games. A number of spins may be determined based upon an amount of a bingo game win or a number of bingo pattern wins, as examples. Sequential display of display patterns/sequences may be controlled until display/communication of a determined number of bingo pattern amounts has been achieved.

In the example embodiment, a game outcome is randomly determined (e.g., by comparing a ball call to a bingo card, by use of an RNG, etc.). A lookup (e.g., or multiple lookups) is then performed (e.g., by a game controller and/or based upon an RNG output) in a lookup table (e.g., 322A-N) to determine how to present the bingo pattern pays (e.g., which script/sequence of outcomes to display).

For example, a lookup table may be configured as a data structure and/or model such that, based upon an inputted/determined total game outcome amount, a script of which display sequence(s) to use to communicate the game outcome amount (e.g., to a player) may be determined. In some embodiments, an RNG output may be utilized to determine which script to use to communicate a particular game outcome amount.

In the example embodiment, credit values associated with any winning bingo patterns that are achieved by the marked or daubed bingo card are evaluated against one or more lookup tables in memory to determine how the credit values will be provided. For instance, in order for both the free spin feature and the multiplier wheel feature to be provided, a lowest credit value must be stored as being associated with a base game outcome that includes two trigger symbols, the highest credit value must be stored as being associated with a multiplier wheel feature outcome, and the remaining credit values must be stored as being associated with free spin outcomes. In other words, not all credit values may be able to be provided via the base game, free spin game, and multiplier wheel game. Accordingly, various combinations of features are envisioned.

In the example embodiment, a logic flow may be processed based on lookups in various lookup tables to determine how to present bingo pattern pays to the player. As one example, if only one bingo pattern pay is achieved, the credit amount associated therewith may be provided as a base game outcome (e.g., no feature games are triggered). A lookup may be performed in a lookup table associated with the base game to determine that the credit amount is able to be provided via a base game outcome (e.g., spin of reels) and, in examples where there are multiple presentations (e.g., base game reel spin outcomes) stored for the credit amount, to determine (e.g., randomly) which presentation to display.

In some embodiments, bingo pattern pays may be combined and, in instances where the bingo pattern pays can be combined, (e.g., into a total bingo pattern pay that is available to be provided via a base game outcome), the total bingo pattern pay may be provided as a base game outcome.

When multiple bingo pattern pays are achieved (e.g., and are not combined into a base game outcome/total bingo pattern pay), a determination is made as to which features of a plurality of features to use to provide the multiple bingo pattern pays. In the example embodiment, at least one lookup table may be configured for each of the base game and each respective feature. In order for the double feature (e.g., free spins and multiplier wheel spin) to be triggered, the system must determine via a lookup in the lookup table for the base game that a bingo pattern pay associated with the lowest amount of the multiple bingo pattern pays has an entry in the lookup table for the base game (e.g., and that the entry includes a flag indicating that the outcome associated therewith includes two trigger symbols), determine via a lookup in the lookup table for the wheel multiplier game that a bingo pattern pay associated with the highest amount of the multiple bingo pattern pays has an entry in the lookup table for the wheel multiplier game, and determine via lookups in the lookup table associated with the free spin game that remaining bingo pattern pays have entries in the lookup table for the free spin game.

As explained herein, in some embodiments many different features may be available to be provided. In the example embodiment, a base game is provided and available features include a free spin feature (e.g., with no multiplier), a “super” free spin feature (e.g., including a multiplier - sometimes referred to herein as the free spin game), a base wheel feature (e.g., not including a multiplier), a wheel multiplier feature (e.g., including a multiplier), and a double metamorphic feature (e.g., including both the wheel multiplier feature and the super free spin feature).

When multiple bingo pattern pays are achieved and not combined into a base game outcome, the system may perform a number of lookups (e.g., queries) in various lookup tables (e.g., in a defined order) to determine how the multiple bingo pattern pays will be provided. In the example embodiment, the respective lookup tables for each of the base game and each feature game include credit amounts that are able to be provided via the respective game. In other words, the base game lookup table includes credit amounts that are able to be provided in the base game, and so forth.

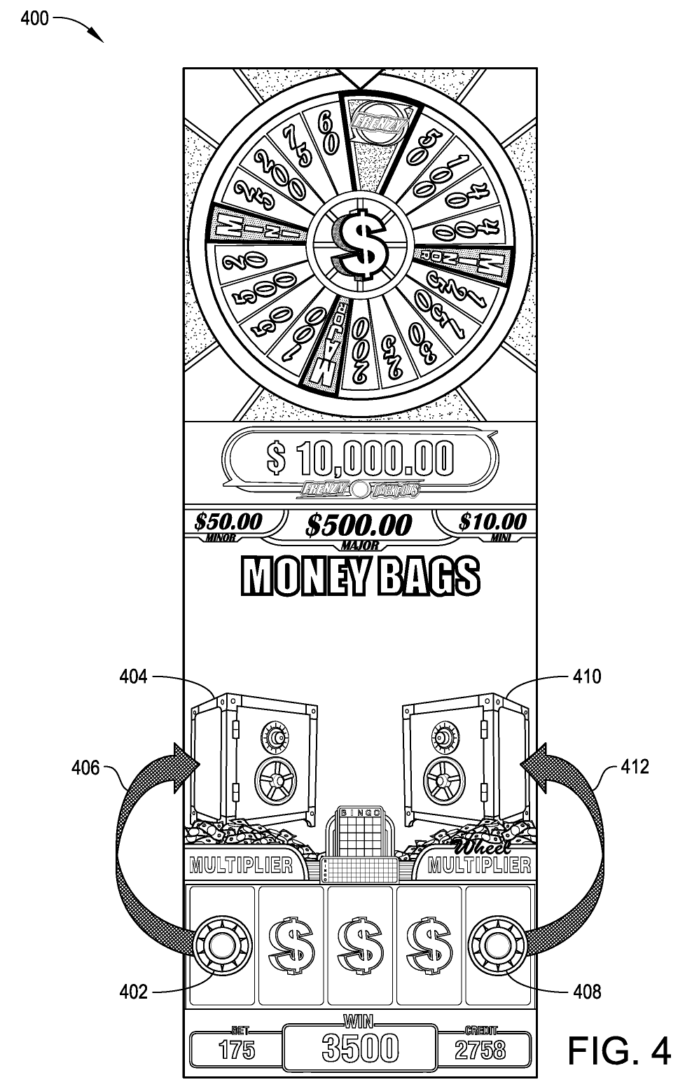

In the example embodiment, during a play of the example game described herein, the system performs a lookup in each of the various lookup tables to determine which of the base game and/or various features can provide the credit amounts corresponding to the credit amounts for each achieved bingo pattern pay. Once the base game and/or various features that are able to provide the credit amounts are determined, a random determination occurs (e.g., based upon an RNG output and a weight table) to select which of the features that are able to be provided, if any, will be used to present the credit amounts. Then, once the features are selected, the presentation for that play of the game (e.g., base game and selected feature(s)) is dynamically generated. For instance, the entries in the lookup tables that are associated with credit amounts may also be associated with identifiers that correspond to which game outcome, for the appropriate game (e.g., base game, feature game, etc.), should be displayed in order to communicate which credit amount is provided (e.g., see FIGS. 4-19). In some embodiments, entries associated with credit amounts in the lookup tables may be associated with more than one identifier, corresponding to more than one way the outcome can be displayed while still being associated with the same credit amount (e.g., different reel outcome options may be associated with the same output amount). In embodiments where entries are associated with more than one identifier, a random determination (e.g., based on an RNG call and/or weight table) may be made between the various identifiers to select an identifier corresponding to how the outcome will be displayed.

For instance, if the double feature is triggered (e.g., based on the various rules described herein), the presentation is dynamically generated to include a base game outcome, a free spin outcome (e.g., or outcomes), and a wheel multiplier outcome. Similarly, if another feature and/or combination of features is triggered, the presentation is dynamically generated to include outcomes from the base game and/or appropriate feature or features.

In some embodiments, if no combination of the base game and/or any feature games are able to provide one or more bingo pattern pays, the free spin game may be triggered and outcomes for the free spin game may be dynamically generated to correspond to the one or more bingo pattern pays. In other words, the double feature may be triggered and the free spin game may be extended within the double feature in order to include the additional spins for the one or more bingo pattern pays, or just the free spin feature may be triggered and include the additional spins for the one or more bingo pattern pays.

In some embodiments, a bingo pattern associated with a relatively high output amount (e.g., a highest priority pay) may be provided and the output amount may be split into a plurality of output amounts. For instance, the output amount may be split into a highest amount (e.g., for the wheel multiplier feature), a lowest amount (e.g., for the base spin), and a plurality of intermediate amounts (e.g., for the free spin feature).

In some embodiments, when splitting up the high output amount, the system may perform various lookups in the lookup tables described herein in order to ensure that each of the amounts the high output amount is split into are available to be provided by the appropriate feature and/or game (e.g., verifying that the lowest amount can be provided via the base game, the highest amount can be provided via the wheel multiplier feature, and the intermediate amounts can be provided via the free spin feature).

Once the high output amount is split appropriately, facade/presentation selection occurs as described herein in order to determine how to display the various outputs the high output amount is split into.

In the example embodiment, an electronic gaming system is described. The electronic gaming system includes at least one memory with instructions stored thereon and at least one processor in communication with the at least one memory. The instructions, when executed by the at least one processor, cause the at least one processor to determine a plurality of credit amounts associated with a play of an electronic game and perform a first lookup in a first lookup table of a plurality of lookup tables in the at least one memory to determine whether a greatest credit amount of the plurality of credit amounts corresponds to a first feature amount stored in the first lookup table wherein the first lookup table is associated with first feature content (e.g., the wheel multiplier feature). The instructions also cause the at least one processor to perform a second lookup in a second lookup table of the plurality of lookup tables in the at least one memory to determine whether a subset of the plurality of credit amounts different from the greatest credit amount correspond to a number of second feature amounts stored in the second lookup table wherein the second lookup table is associated with second feature content (e.g., the super red screen free spins game). The instructions further cause the at least one processor to, based upon the greatest credit amount corresponding to the first feature amount stored in the first lookup table and the subset of the plurality of credit amounts different from the greatest credit amount corresponding to the number of second feature amounts stored in the second lookup table, cause the plurality of credit amounts to be presented via display of at least the first feature content and the second feature content (e.g., and/or base content).

In some embodiments, the instructions further cause the at least one processor to perform a third lookup in a third lookup table of the plurality of lookup tables stored in the at least one memory to determine whether a lowest credit amount of the plurality of credit amounts corresponds to a base amount stored in the third lookup table wherein the third lookup table is associated with base game content and, based upon the lowest credit amount corresponding to the base amount, cause the plurality of credit amounts to further be presented via display of the base game content. In some embodiments, the instructions further cause the at least one processor to determine that the base amount stored in the third lookup table is stored as being associated with a plurality of trigger symbols (e.g., and/or a flag in memory indicating that the base amount can be provided with the trigger symbols), the plurality of trigger symbols including a first trigger symbol associated with the first feature content and a second trigger symbol associated with the second feature content and cause the plurality of credit amounts to be presented via display of at least the first feature content and the second feature content further based upon the base amount being stored in the third lookup table as being associated with the plurality of trigger symbols including the first trigger symbol and the second trigger symbol. In some embodiments, the first feature content includes wheel spin content, and wherein the second feature content includes free spin content.

In some embodiments, the instructions further cause the at least one processor to determine the plurality of credit amounts based upon a plurality of bingo pattern pays associated with a bingo card and a ball call. In some embodiments, the instructions further cause the at least one processor to receive one or more messages from a bingo server, the one or more messages associated with at least one of the plurality of bingo pattern pays, the bingo card, or the ball call.

In some embodiments, the instructions further cause the at least one processor to sort the plurality of credits amounts from least to greatest. In some embodiments, the instructions further cause the at least one processor to cause the plurality of credit amounts to be presented from least to greatest based upon the sorting.

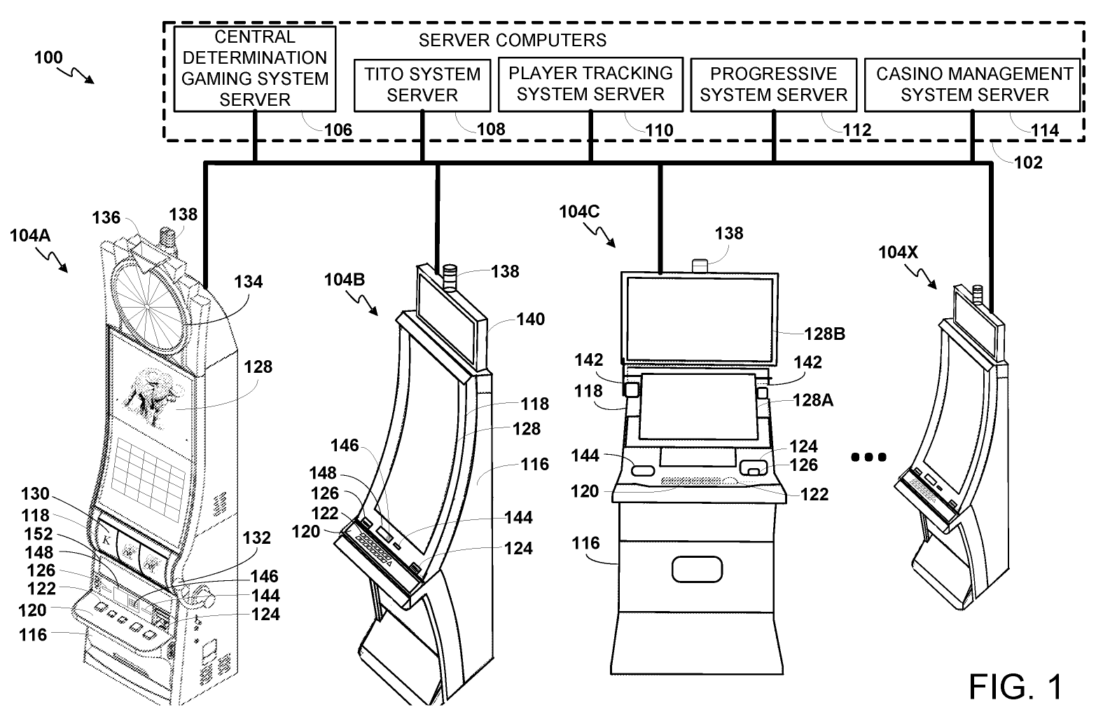

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XLTM model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player’s smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

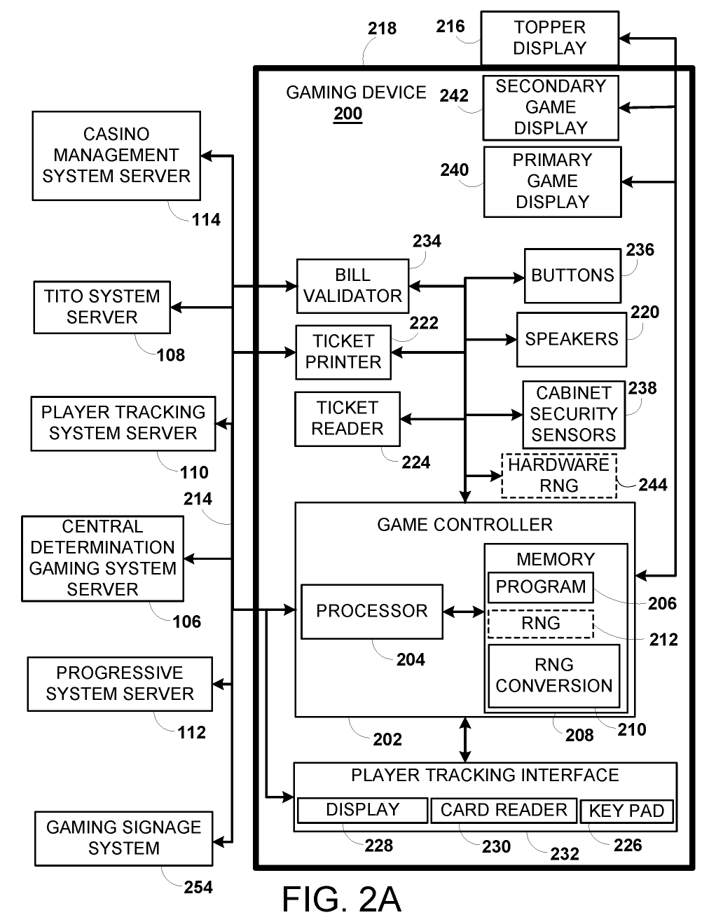

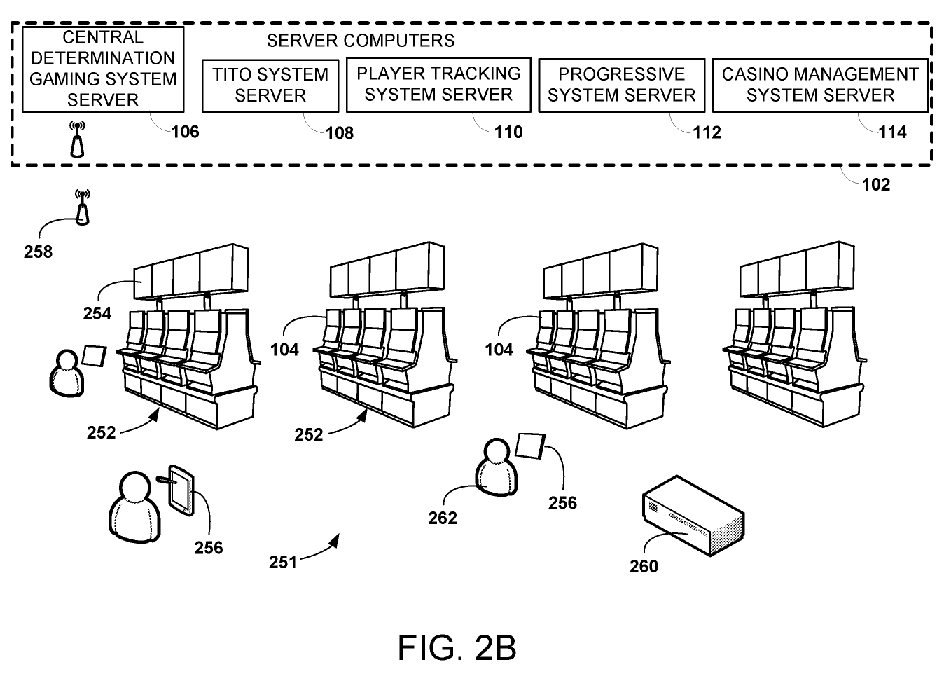

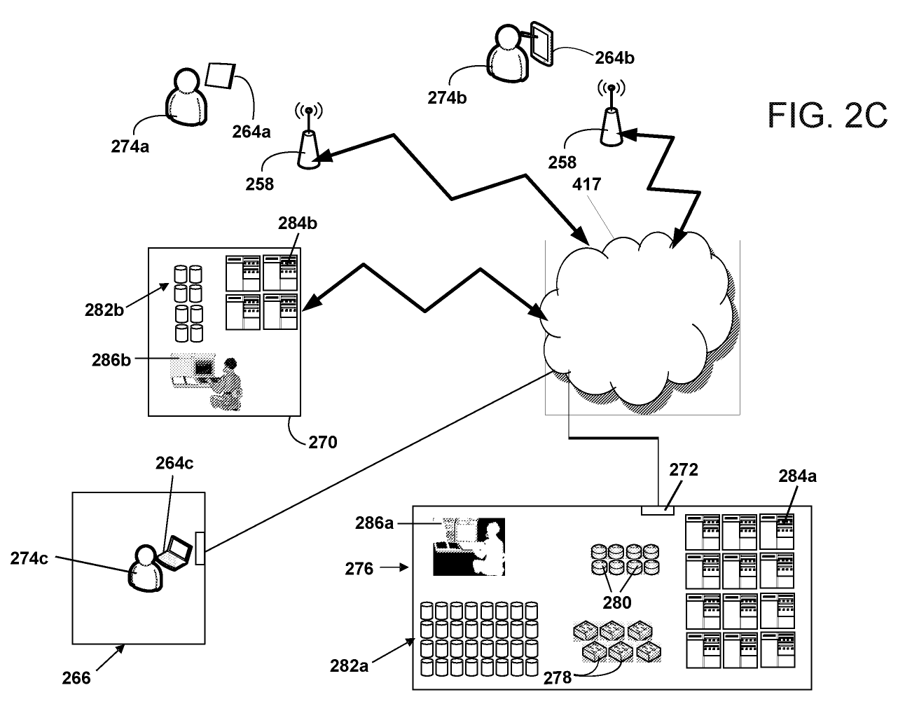

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the ArcTM model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the HelixTM model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player’s credit value, a ticket reader 224 which reads bar-coded tickets or other media or mechanisms for storing or indicating a player’s credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75 %). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron’s player loyalty card, a patron’s smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player’s EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a–274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player’s “cash in” selections, wagering game results and a player’s “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a–274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

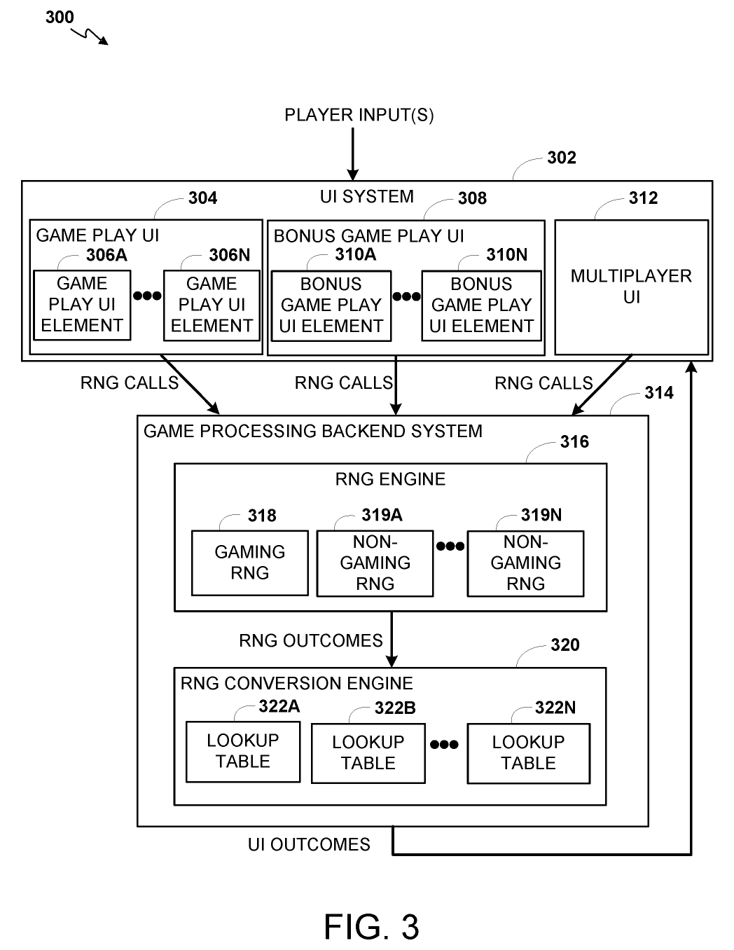

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player’s gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine bcould utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

FIGS. 4-19 illustrate an example presentation that is dynamically constructed by an example system described herein and includes a base game, a free spin feature, and a multiplier wheel feature.

FIG. 4 illustrates an example screenshot and/or interface 400 of a base game, in accordance with the present disclosure. To begin play of the example electronic game described herein, a player may provide an input (e.g., selection of a button, a wager, etc.). As shown in FIG. 4, a trigger symbol 402 associated with a metamorphic 404 (e.g., a symbol that communicates when a particular feature has been triggered and/or how long it has been since the particular feature has been triggered) and a free spin feature (e.g., a super red screen free spins (SRSFS) feature, including one or more free spins and multipliers applied to the one or more free spins) is provided on a first reel of a plurality of reels, thereby triggering the free spin feature, as illustrated by an arrow 406. A trigger symbol 408 associated with a metamorphic 410 and a multiplier wheel feature is provided on a fifth reel of the plurality of reels, thereby triggering the multiplier wheel feature, as illustrated by an arrow 412. Other types of features are also envisioned within the scope of the present disclosure (e.g., a hold and spin feature, etc.).

In some embodiments, both features may only be triggered when both trigger symbol 402 and trigger symbol 408 are provided on the reels during the base game. Other triggers for the free spin and multiplier wheel features are also envisioned within the scope of the present disclosure.

In the example embodiment, the free spin feature is played first and the wheel multiplier feature is played second. A total output amount for the play of the game is cumulative between both features and the base game.

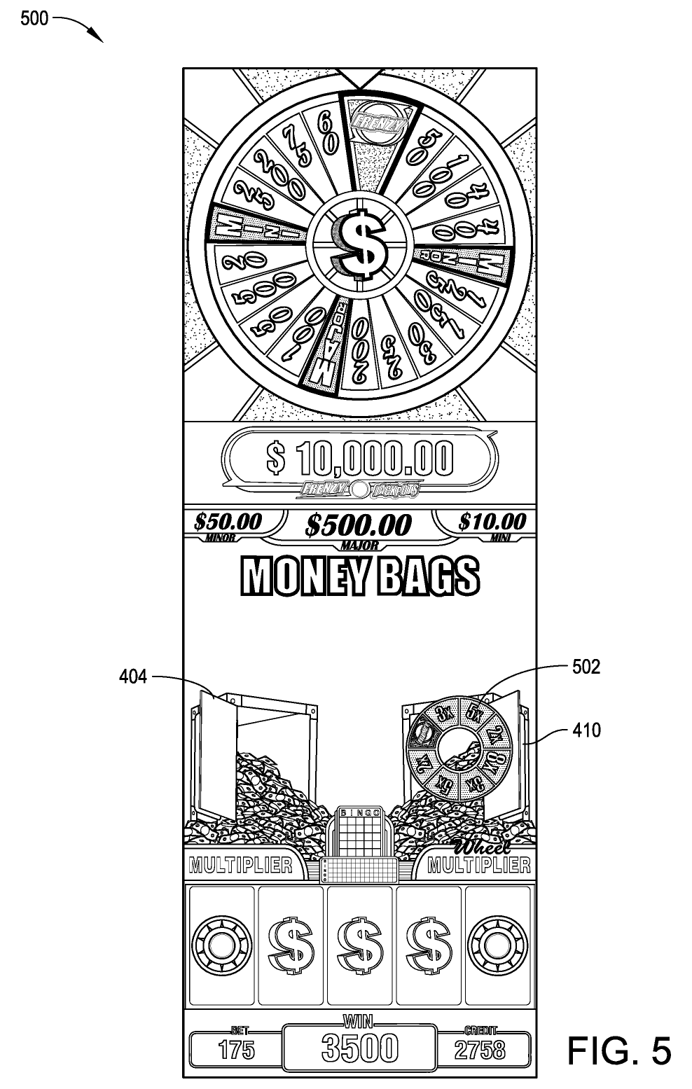

FIG. 5 illustrates another example screenshot and/or interface 500 of the base game shown in FIG. 4. Because both features have been triggered, in FIG. 5 metamorphic 404 is shown as animating (e.g., to a maximum, or open, state) and metamorphic 410 is shown as animating (e.g., to a maximum, or open, state and including a multiplier wheel 502) to communicate that both features have been triggered.

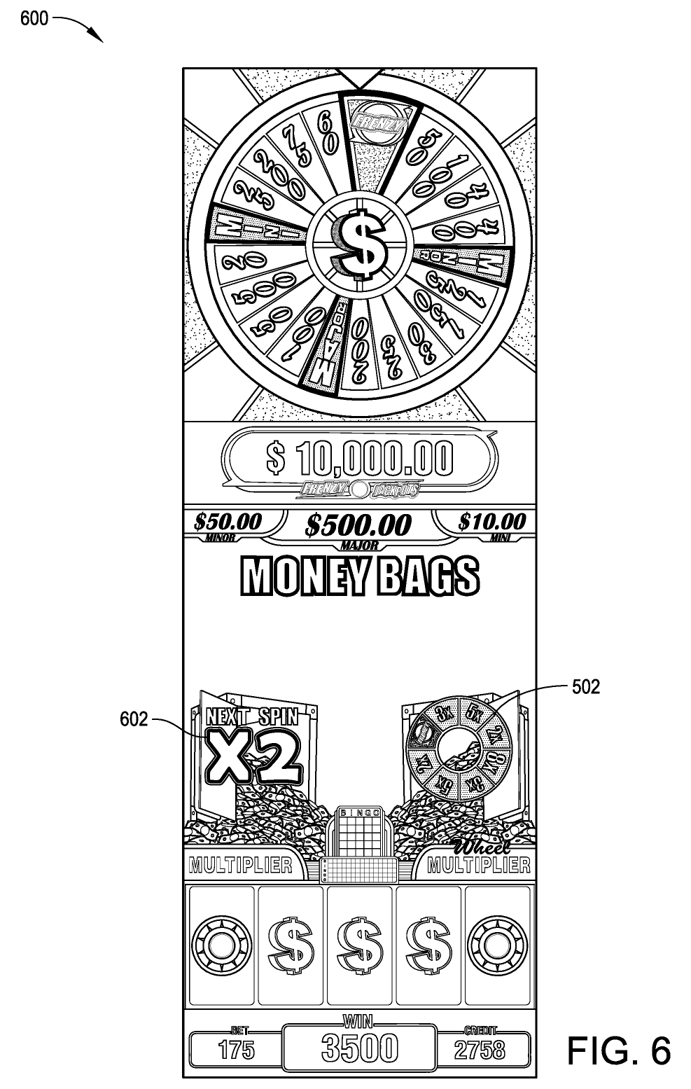

FIG. 6 illustrates an example screenshot and/or interface 600 of a feature game, in accordance with the present disclosure. As shown in FIG. 6, the first feature has begun. In the example embodiment, screenshot and/or interface 600 includes a colored tint (e.g., a red tint). In some embodiments, the colored tint may cover all of screenshot and/or interface 600 other than a “NEXT SPIN” message that is displayed in between free spins.

In the example embodiment, the reels spin (e.g., in random directions) and spin outcomes are provided in order of increasing output amounts. Notably, a difference between the free spin feature illustrated in FIG. 6 (e.g., the SRSFS) and another free spin feature described herein (e.g., red screen free spins (RSFS)) is that multipliers (e.g., randomly determined) are applied to output amounts associated with each respective free spin.

In the example embodiment, a multiplier for a next spin may be displayed after a current spin, a “NEXT SPIN” message may be displayed to indicate that a next free spin is about to occur where the displayed multiplier will be applied.

In some embodiments, multiplier wheel 502 may spin slowly (e.g., in an attract mode) during the free spin feature (e.g., before the multiplier wheel feature begins).

As shown in FIG. 6, a 2x multiplier 602 is provided and will be applied to a first spin of the free spins.

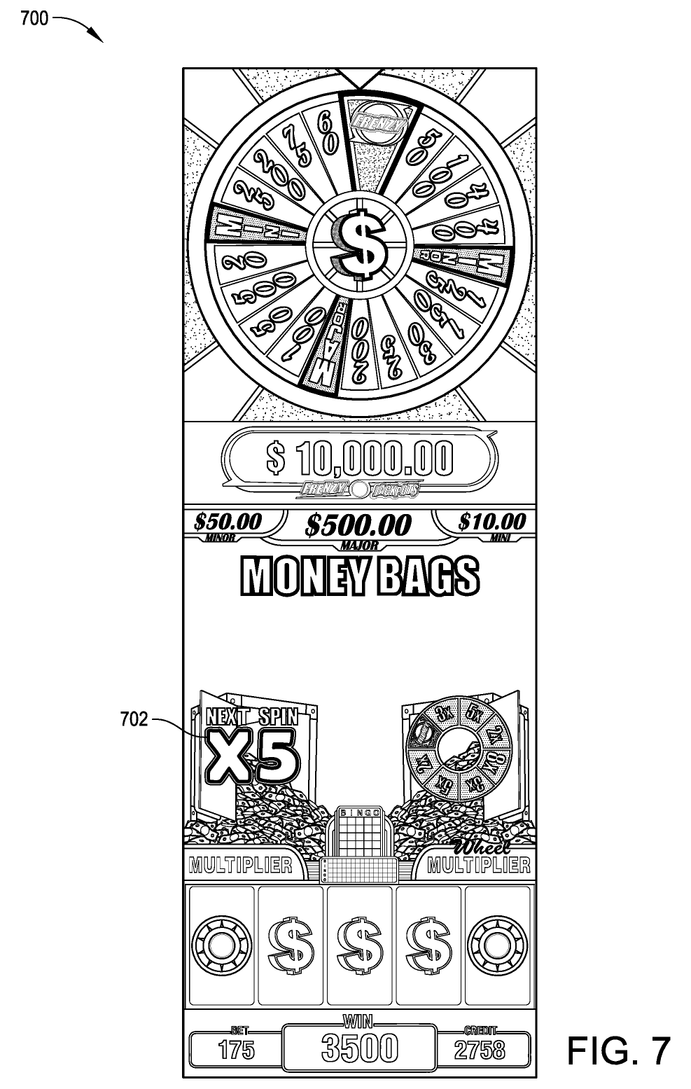

FIG. 7 illustrates another example screenshot and/or interface 700 of the feature game shown in FIG. 6. For instance, screenshot and/or interface 700 may be displayed after an outcome for the first spin (e.g., associated with 2x multiplier 602, shown in FIG. 6) of the free spins is provided. As shown in FIG. 7, a 5x multiplier 702 will be applied to a second spin of the free spins.

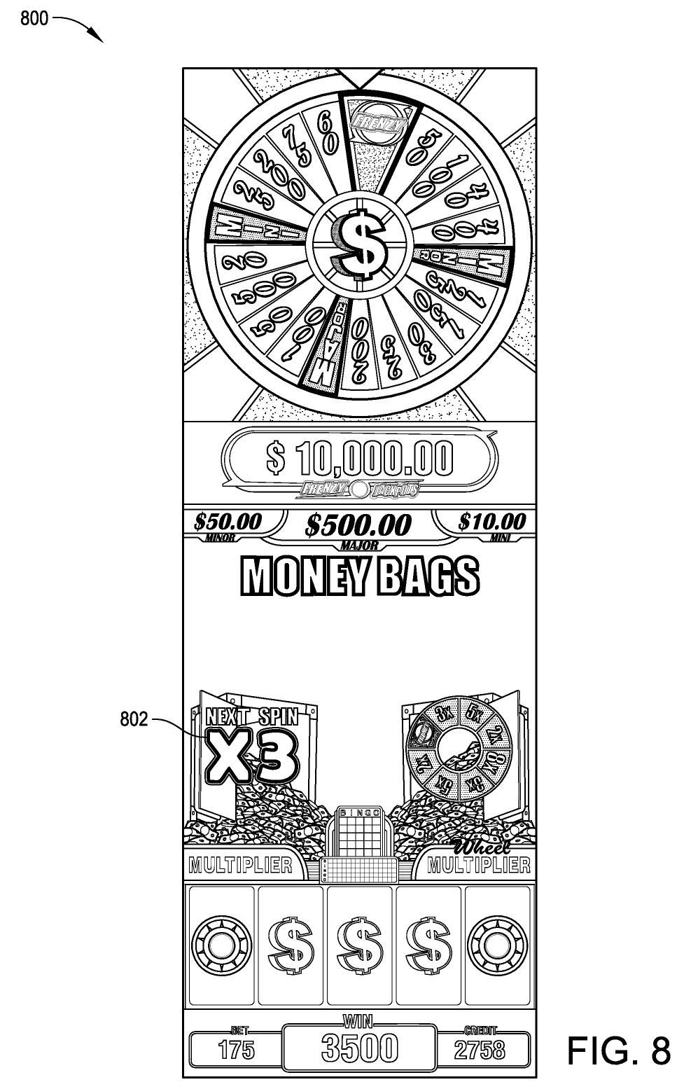

FIG. 8 illustrates another example screenshot and/or interface 800 of the feature game shown in FIG. 6. For instance, screenshot and/or interface 800 may be displayed after an outcome for the second spin (e.g., associated with 5x multiplier 702, shown in FIG. 7) of the free spins is provided. As shown in FIG. 8, a 3x multiplier 802 will be applied to a third spin of the free spins.

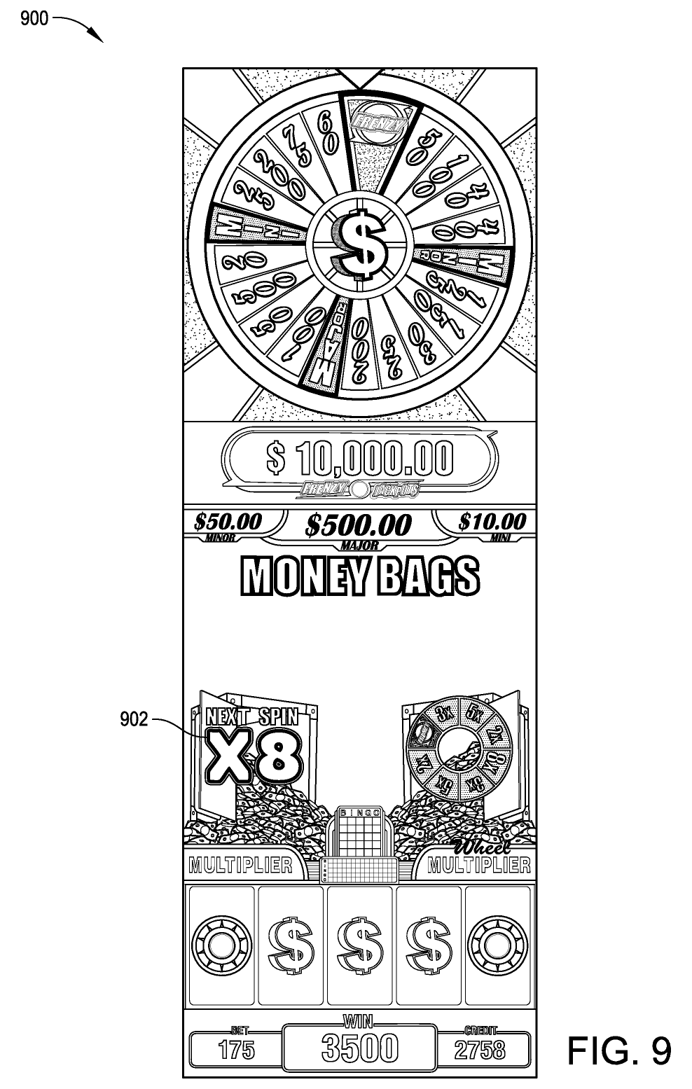

FIG. 9 illustrates another example screenshot and/or interface 900 of the feature game shown in FIG. 6. For instance, screenshot and/or interface 900 may be displayed after an outcome for the third spin (e.g., associated with 3x multiplier 802, shown in FIG. 8) of the free spins is provided. As shown in FIG. 9, an 8x multiplier 902 will be applied to a fourth spin of the free spins. In the illustrated example, the fourth spin is the last spin of the free spin feature.

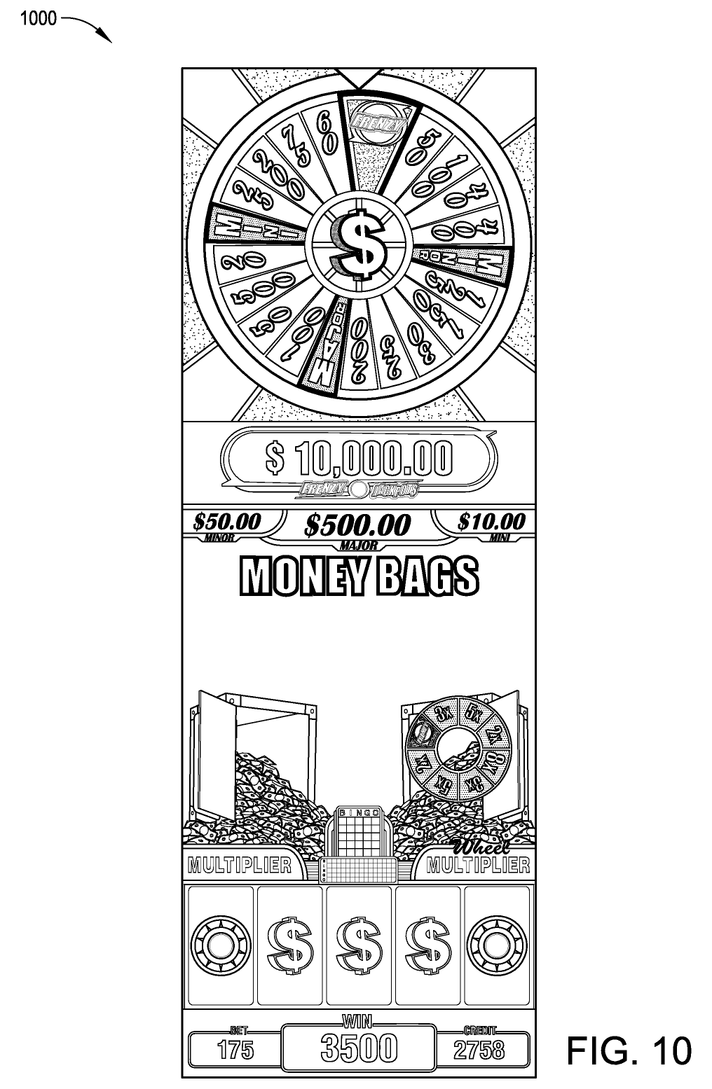

FIG. 10 illustrates an example screenshot and/or interface 1000 of another feature game, in accordance with the present disclosure. As shown in FIG. 10, the free spin feature has ended. Accordingly, the colored tint is removed. A total amount provided during the free spins (e.g., and the base game play) may remain displayed in a win meter to illustrate that win amounts from the free spin feature (e.g., and base game) and the multiplier wheel feature are cumulative.

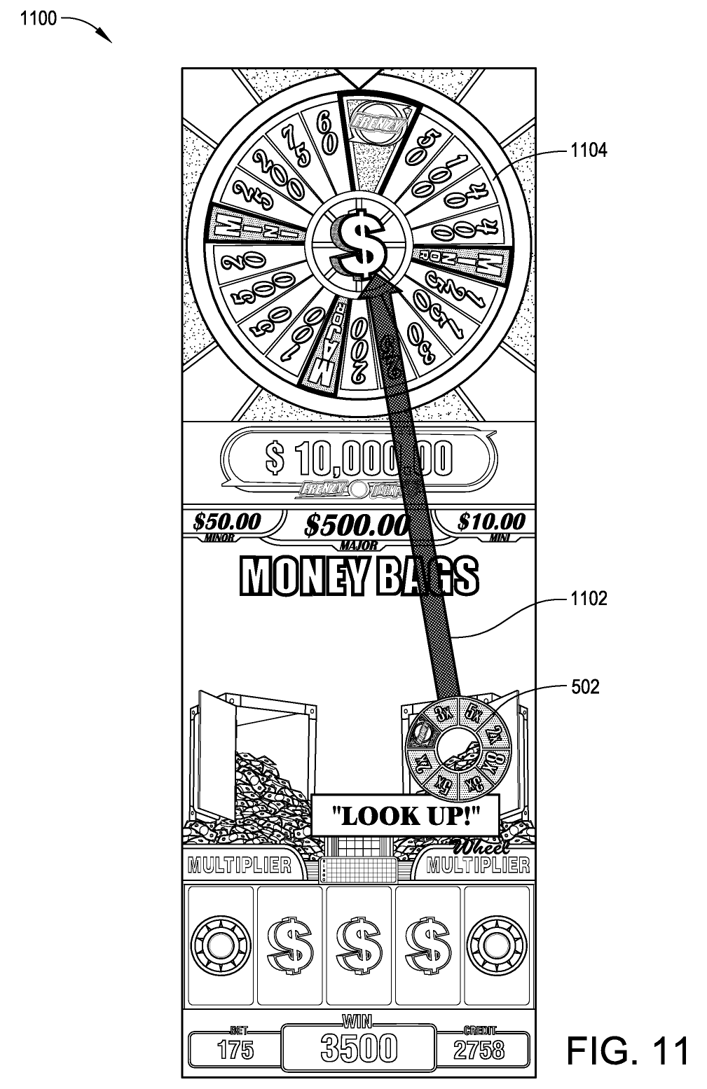

FIG. 11 illustrates another example screenshot and/or interface 1100 of the feature game shown in FIG. 10. As shown in FIG. 11, an animation 1102 (e.g., a particle trail, messaging, etc.) is provided to draw attention to a credit wheel 1104. Animation 1102, illustrated as an arrow in FIG. 11, illustrates that multiplier wheel 502 may be displayed as being animated (e.g., flying, accompanied by a particle trail) to a center of credit wheel 1104 (e.g., to communicate that multiplier wheel 502 will be applied in the multiplier wheel feature).

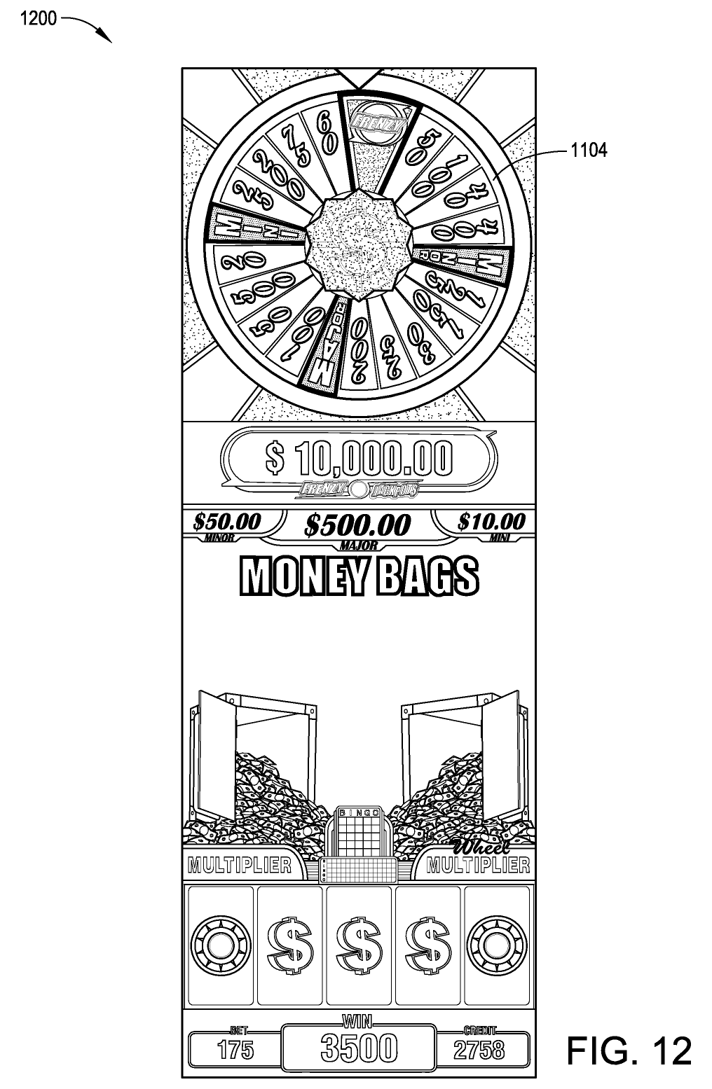

FIG. 12 illustrates another example screenshot and/or interface 1200 of the feature game shown in FIG. 10. As shown in FIG. 12, a center of credit wheel 1104 is animated to an “ON” state (e.g., may include animations, effects, particles, a feature message) to communicate that the wheel multiplier feature is active.

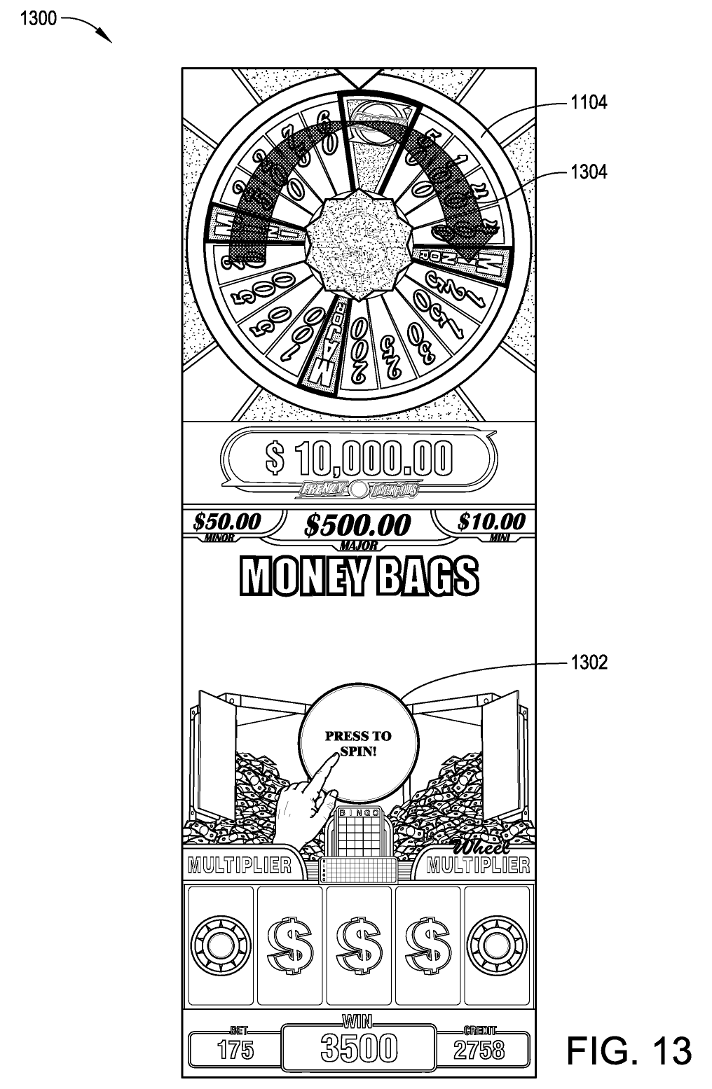

FIG. 13 illustrates another example screenshot and/or interface 1300 of the feature game shown in FIG. 10. As shown in FIG. 13, a player is prompted to initiate a spin of credit wheel 1104 (e.g., by selecting a button 1302). In some embodiments, inputs to begin a player spin may be provided at a plurality of locations including above credit meters, on a play/bash button, and on a button deck (e.g., a virtual button deck), as examples. Upon selection to begin a spin, credit wheel 1104 begins spinning (e.g., clockwise), as illustrated by arrow 1304.

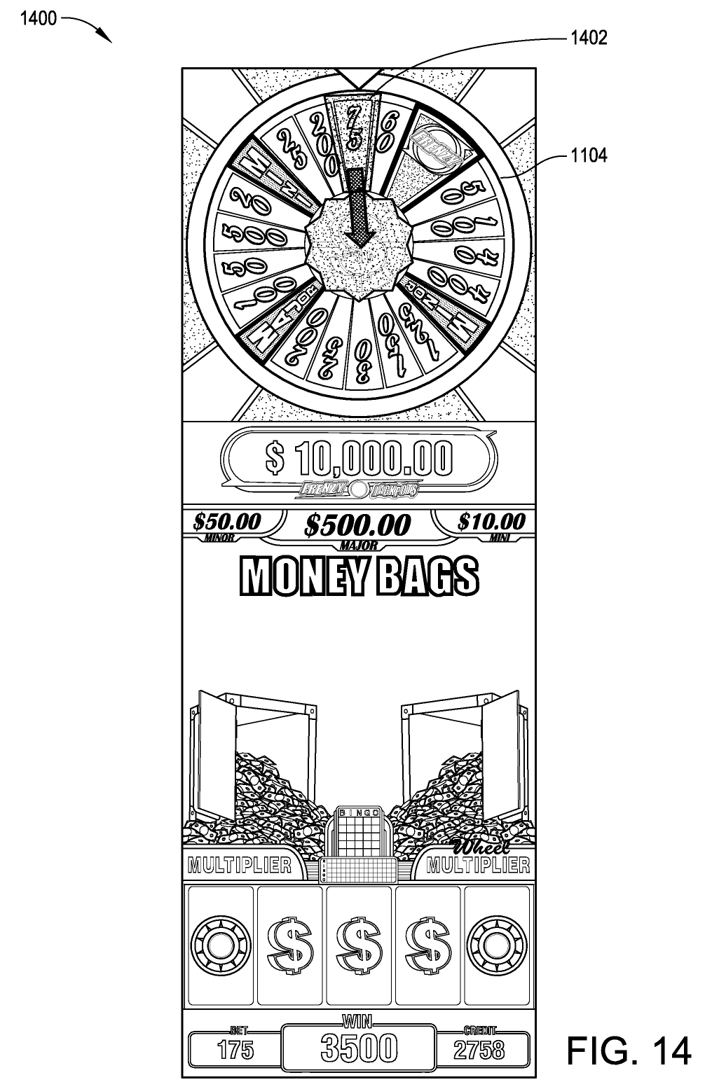

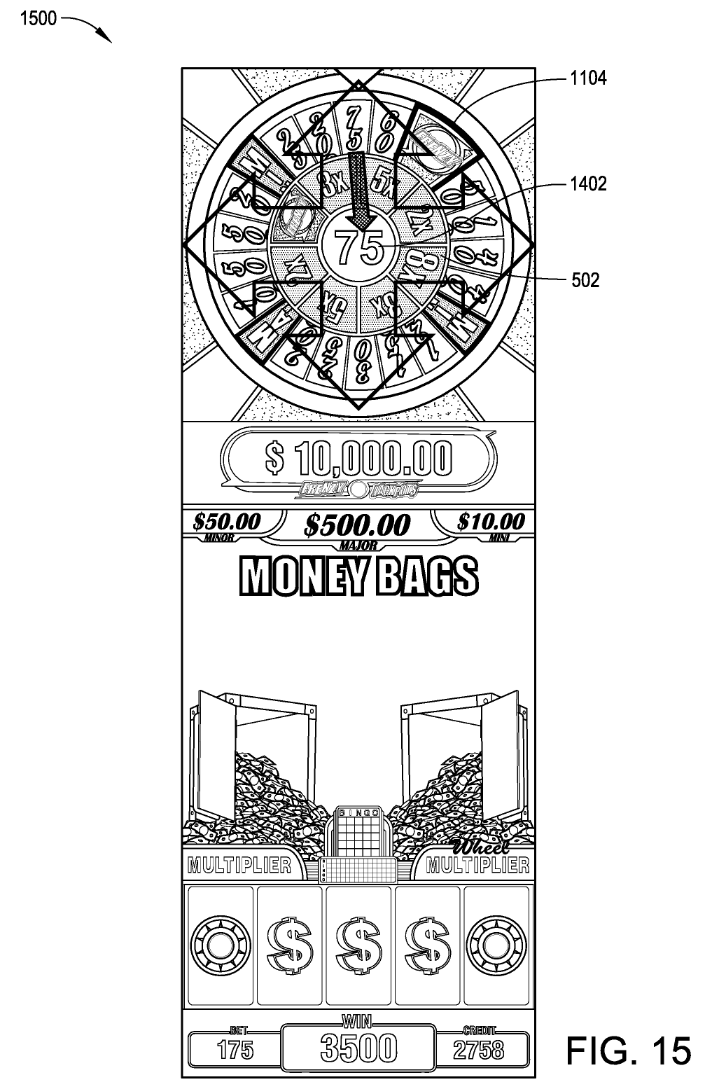

FIG. 14 illustrates another example screenshot and/or interface 1400 of the feature game shown in FIG. 10. As shown in FIG. 14, credit wheel 1104 has stopped spinning and a credit value is provided (e.g., here, 75 credits). Accordingly, a wedge 1402 of credit wheel 1104 is displayed as being highlighted to communicate that the credit value associated therewith is provided. In some embodiments, wedges of credit wheel 1104 (e.g., credit wheel outputs eligible to be provided) may include credit amounts, static jackpot amounts, and progressive jackpot amounts. In the example embodiment, the credit value associated with wedge 1402 may be animated as traveling from wedge 1402 to the center of credit wheel 1104 (e.g., see FIG. 15, where “75” is displayed at the center of credit wheel 1104).

FIG. 15 illustrates another example screenshot and/or interface 1500 of the feature game shown in FIG. 10. As shown in FIG. 15, after the credit amount associated with wedge 1402 travels to the center of credit wheel 1104, multiplier wheel 502 may be displayed as being animated (e.g., growing) outward from behind the credit amount. Multiplier wheel 502 eventually replaces credit wheel 1104, indicating that multiplier wheel 502 is available to be spun.

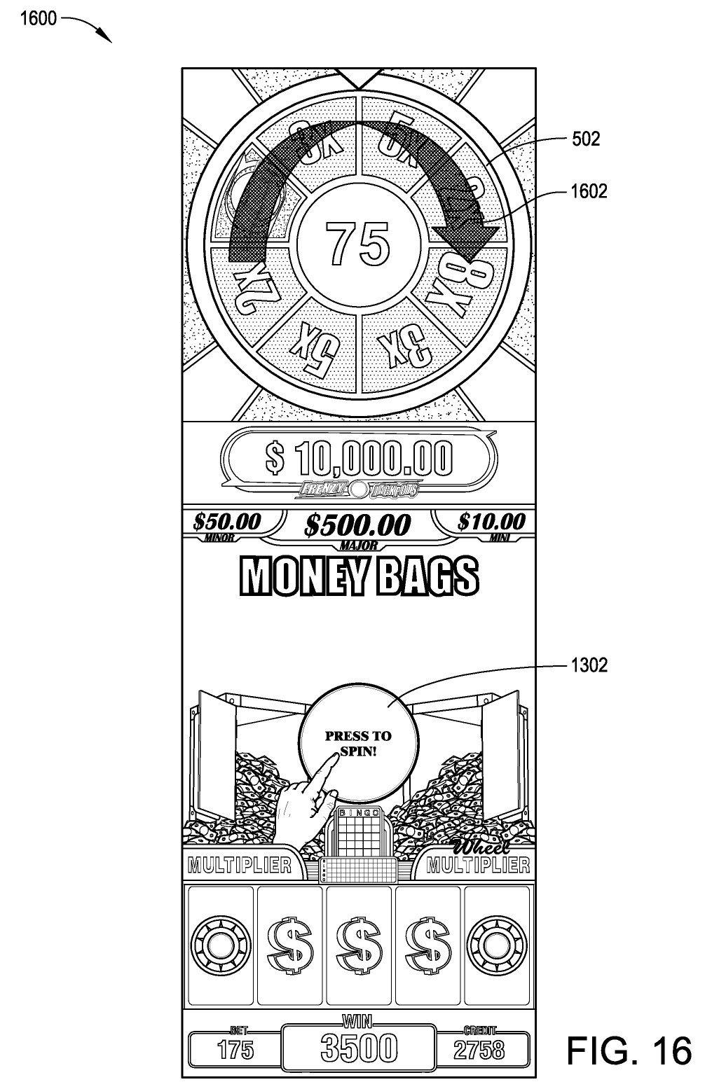

FIG. 16 illustrates another example screenshot and/or interface 1600 of the feature game shown in FIG. 10. As shown in FIG. 16, a player is prompted to initiate a spin of multiplier wheel 502 (e.g., by selecting button 1302). In some embodiments, inputs to begin a player spin may be provided at a plurality of locations including above credit meters, on a play/bash button, and on a button deck (e.g., a virtual button deck), as examples. Upon selection to begin a spin, multiplier wheel 502 begins spinning (e.g., clockwise), as illustrated by arrow 1602.

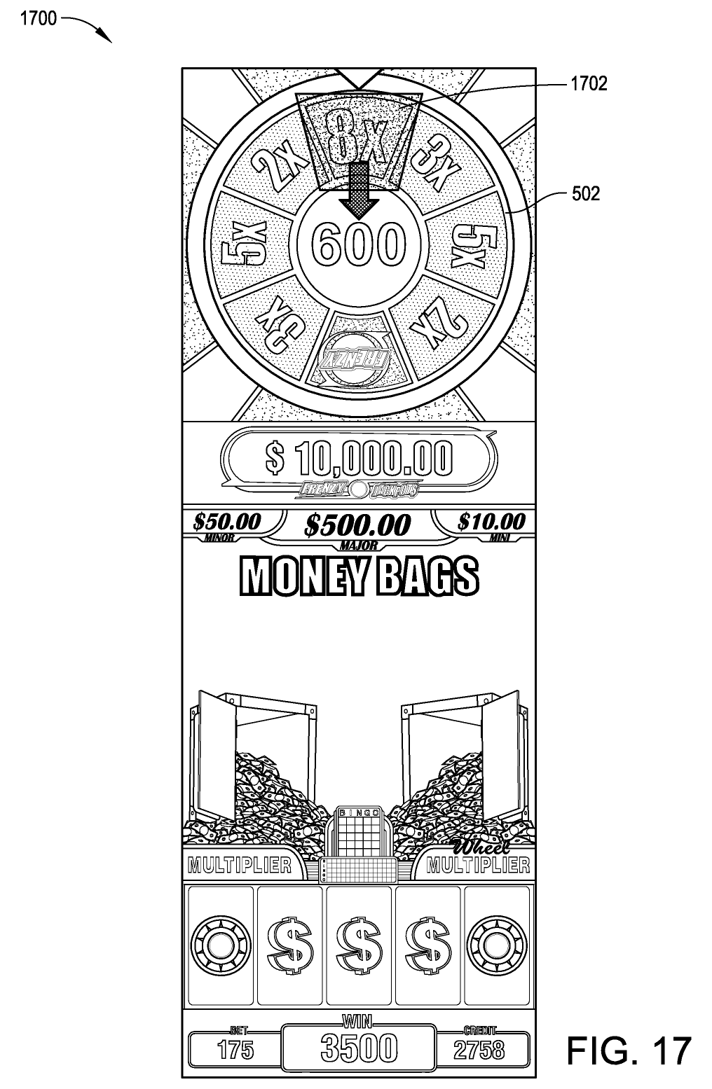

FIG. 17 illustrates another example screenshot and/or interface 1700 of the feature game shown in FIG. 10. As shown in FIG. 17, multiplier wheel 502 has stopped and a multiplier is provided (e.g., here, 8x). Accordingly, a wedge 1702 of multiplier wheel 502 is displayed as being highlighted to communicate that the multiplier associated therewith is provided. In some embodiments, wedges of multiplier wheel 502 may include multipliers, jackpot amounts, and progressive jackpot amounts. In the example embodiment, the multiplier associated with wedge 1702 may be animated as traveling from wedge 1702 to the center of multiplier wheel 502 and hitting (e.g., being applied to) the credit value provided from the spin of credit wheel 1104. Accordingly, in this example, the credit amount of 75 (e.g., shown in FIG. 16) is updated to a credit amount of 600 (e.g., 75 x 8 = 600). In embodiments where a jackpot amount or progressive jackpot amount is provided based on a spin of multiplier wheel 502, the jackpot amount or progressive jackpot amount may be provided in addition to the credit value provided based on the spin of credit wheel 1104.

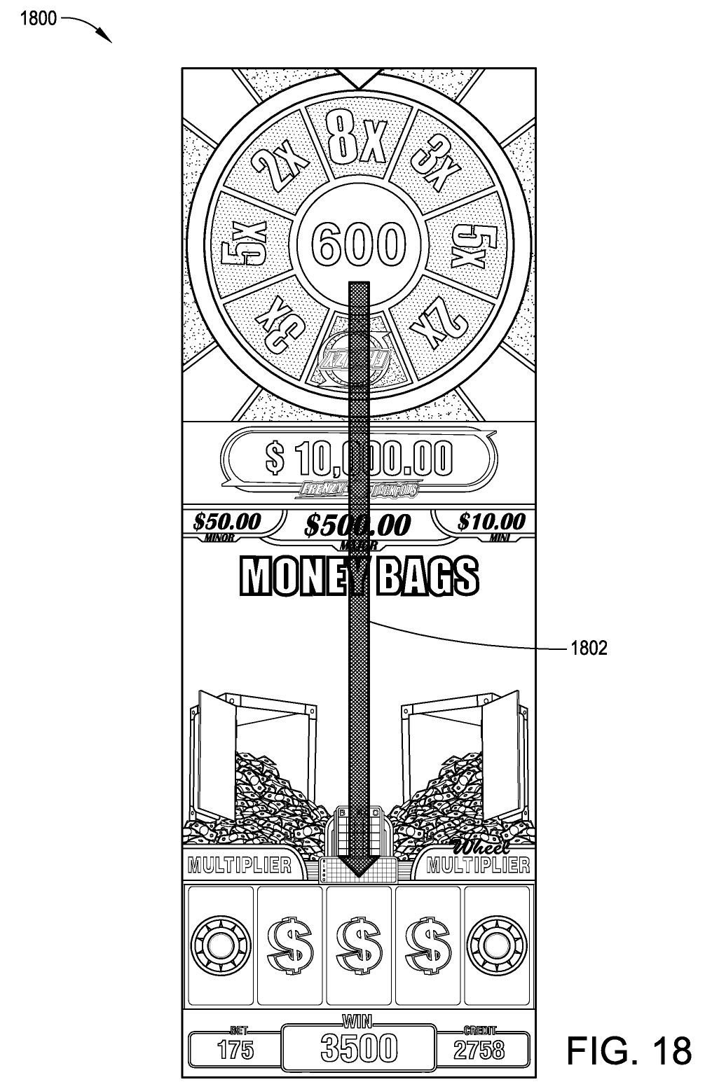

FIG. 18 illustrates another example screenshot and/or interface 1800 of the feature game shown in FIG. 10. As shown in FIG. 18, arrow 1802 illustrates that the total output amount (e.g., based on the spin of credit wheel 1104 and the spin of multiplier wheel 502) is displayed as being animated downward (e.g., including a particle trail, messaging, etc.) from the center of multiplier wheel 502 to a win meter. A total credit amount from the free spin feature was previously provided at the win meter and is now added to the total output amount for the wheel multiplier feature.

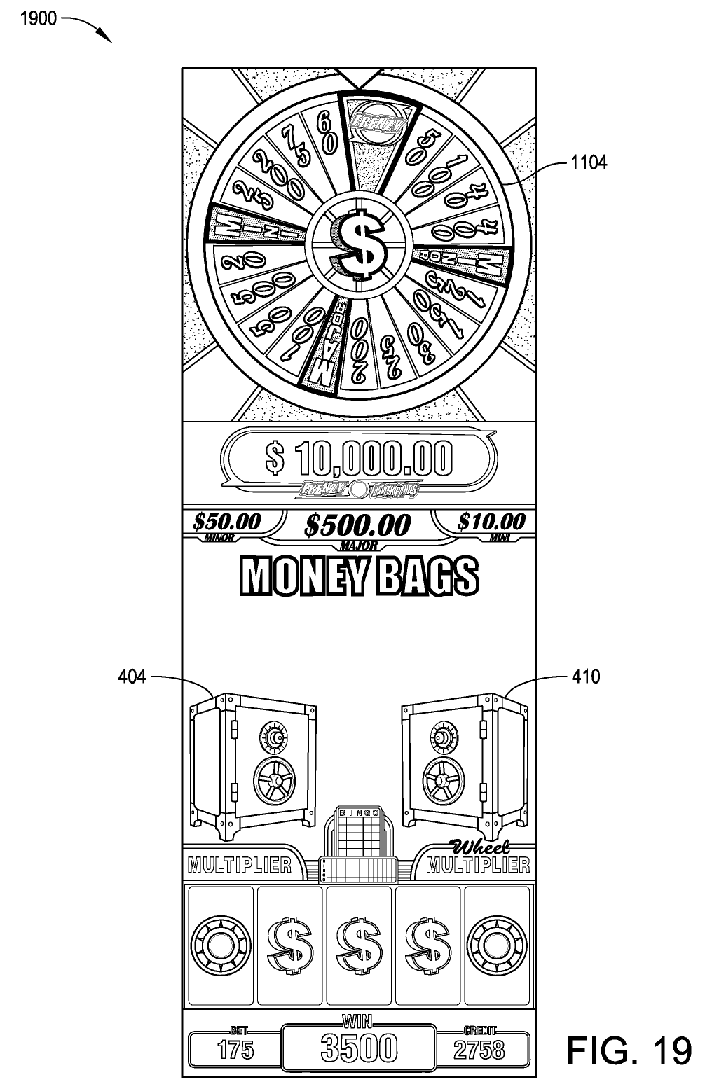

FIG. 19 illustrates another example screenshot and/or interface 1900 of the base game shown in FIG. 4. As shown in FIG. 19, the double feature game has ended and gameplay returns to the base game. Accordingly, multiplier wheel 502 transitions back to credit wheel 1104, and metamorphics 404, 410 are animated back to an initial (e.g., closed) state.

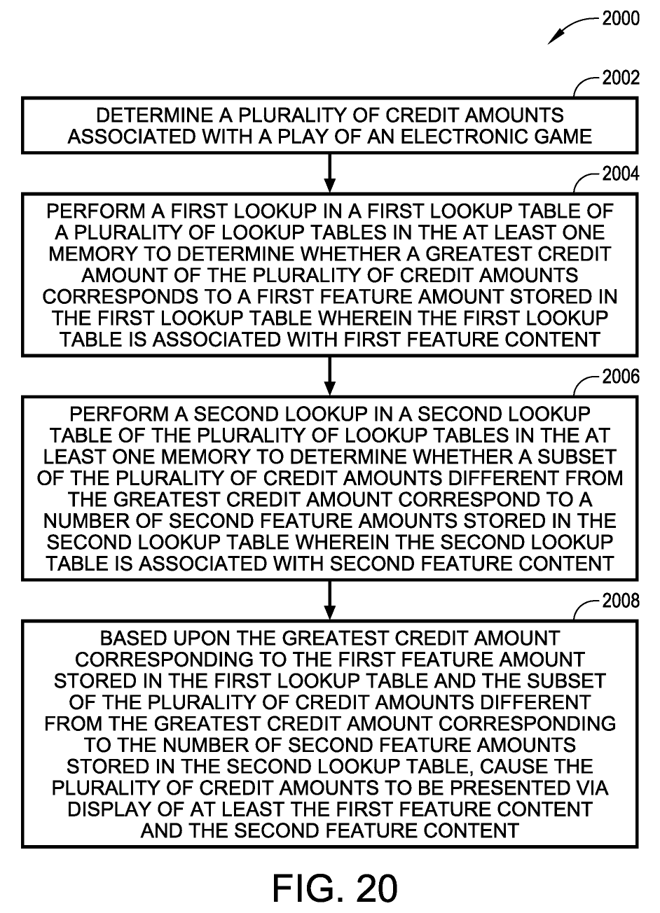

FIG. 20 illustrates an example method 2000 of electronic gaming including a double feature trigger, in accordance with the present disclosure.

In the example embodiment, method 2000 includes determining 2002 a plurality of credit amounts associated with a play of an electronic game and performing 2004 a first lookup in a first lookup table of a plurality of lookup tables in memory to determine whether a greatest credit amount of the plurality of credit amounts corresponds to a first feature amount stored in the first lookup table wherein the first lookup table is associated with first feature content.

Method 2000 also includes performing 2006 a second lookup in a second lookup table of the plurality of lookup tables in memory to determine whether a subset of the plurality of credit amounts different from the greatest credit amount correspond to a number of second feature amounts stored in the second lookup table wherein the second lookup table is associated with second feature content. Method 2000 further includes, based upon the greatest credit amount corresponding to the first feature amount stored in the first lookup table and the subset of the plurality of credit amounts different from the greatest credit amount corresponding to the number of second feature amounts stored in the second lookup table, causing 2008 the plurality of credit amounts to be presented via display of at least the first feature content and the second feature content.

In some embodiments, method 2000 includes performing a third lookup in a third lookup table of the plurality of lookup tables stored in the at least one memory to determine whether a lowest credit amount of the plurality of credit amounts corresponds to a base amount stored in the third lookup table wherein the third lookup table is associated with base game content, determining that the base amount stored in the third lookup table is stored as being associated with a plurality of trigger symbols, the plurality of trigger symbols including a first trigger symbol associated with the first feature content and a second trigger symbol associated with the second feature content, based upon the lowest credit amount corresponding to the base amount, causing the plurality of credit amounts to further be presented via display of the base game content, and causing the plurality of credit amounts to be presented via display of at least the first feature content and the second feature content further based upon the base amount being stored in the third lookup table as being associated with the plurality of trigger symbols including the first trigger symbol and the second trigger symbol wherein the first feature content includes wheel spin content and wherein the second feature content includes free spin content.

In some embodiments, method 2000 includes receiving one or messages from a bingo server, the one or more messages associated with at least one of a plurality of bingo pattern pays, a bingo card, or a ball call, and determining the plurality of credit amounts based upon the plurality of bingo pattern pays associated with the bingo card and the ball call.

In some embodiments, method 2000 includes sorting the plurality of credits amounts from least to greatest and causing the plurality of credit amounts to be presented from least to greatest based upon the sorting.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. An electronic gaming device comprising:
at least one memory with instructions stored thereon; and
at least one processor in communication with the at least one memory, wherein the instructions, when executed by the at least one processor, cause the at least one processor to:
determine a plurality of credit amounts associated with a play of an electronic game;
perform a first lookup in a first lookup table of a plurality of lookup tables in the at least one memory to determine whether a greatest credit amount of the plurality of credit amounts corresponds to a first feature amount stored in the first lookup table, wherein the first lookup table is associated with first feature content;
perform a second lookup in a second lookup table of the plurality of lookup tables in the at least one memory to determine whether a subset of the plurality of credit amounts different from the greatest credit amount correspond to a number of second feature amounts stored in the second lookup table, wherein the second lookup table is associated with second feature content; and
based upon the greatest credit amount corresponding to the first feature amount stored in the first lookup table and the subset of the plurality of credit amounts different from the greatest credit amount corresponding to the number of second feature amounts stored in the second lookup table, cause the plurality of credit amounts to be presented via display of at least the first feature content and the second feature content.

2. The electronic gaming device of claim 1, wherein the instructions further cause the at least one processor to:
perform a third lookup in a third lookup table of the plurality of lookup tables stored in the at least one memory to determine whether a lowest credit amount of the plurality of credit amounts corresponds to a base amount stored in the third lookup table, wherein the third lookup table is associated with base game content; and
based upon the lowest credit amount corresponding to the base amount, cause the plurality of credit amounts to further be presented via display of the base game content.

3. The electronic gaming device of claim 2, wherein the instructions further cause the at least one processor to:
determine that the base amount stored in the third lookup table is stored as being associated with a plurality of trigger symbols, the plurality of trigger symbols comprising a first trigger symbol associated with the first feature content and a second trigger symbol associated with the second feature content; and
cause the plurality of credit amounts to be presented via display of at least the first feature content and the second feature content further based upon the base amount being stored in the third lookup table as being associated with the plurality of trigger symbols comprising the first trigger symbol and the second trigger symbol.

4. The electronic gaming device of claim 2, wherein the first feature content comprises wheel spin content, and wherein the second feature content comprises free spin content.

5. The electronic gaming device of claim 1, wherein the instructions further cause the at least one processor to determine the plurality of credit amounts based upon a plurality of bingo pattern pays associated with a bingo card and a ball call.

6. The electronic gaming device of claim 5, wherein the instructions further cause the at least one processor to receive one or messages from a bingo server, the one or more messages associated with at least one of the plurality of bingo pattern pays, the bingo card, or the ball call.

7. The electronic gaming device of claim 1, wherein the instructions further cause the at least one processor to sort the plurality of credits amounts from least to greatest.

8. The electronic gaming device of claim 7, wherein the instructions further cause the at least one processor to cause the plurality of credit amounts to be presented from least to greatest based upon the sorting.

9. At least one non-transitory computer-readable storage medium with instructions stored thereon that, in response to execution by at least one processor, cause the at least one processor to:
determine a plurality of credit amounts associated with a play of an electronic game;
perform a first lookup in a first lookup table of a plurality of lookup tables in the at least one non-transitory computer-readable storage medium to determine whether a greatest credit amount of the plurality of credit amounts corresponds to a first feature amount stored in the first lookup table, wherein the first lookup table is associated with first feature content;
perform a second lookup in a second lookup table of the plurality of lookup tables in the at least one non-transitory computer-readable storage medium to determine whether a subset of the plurality of credit amounts different from the greatest credit amount correspond to a number of second feature amounts stored in the second lookup table, wherein the second lookup table is associated with second feature content; and
based upon the greatest credit amount corresponding to the first feature amount stored in the first lookup table and the subset of the plurality of credit amounts different from the greatest credit amount corresponding to the number of second feature amounts stored in the second lookup table, cause the plurality of credit amounts to be presented via display of at least the first feature content and the second feature content.

10. The at least one non-transitory computer-readable storage medium of claim 9, wherein the instructions further cause the at least one processor to:
perform a third lookup in a third lookup table of the plurality of lookup tables stored in the at least one non-transitory computer-readable storage medium to determine whether a lowest credit amount of the plurality of credit amounts corresponds to a base amount stored in the third lookup table, wherein the third lookup table is associated with base game content; and
based upon the lowest credit amount corresponding to the base amount, cause the plurality of credit amounts to further be presented via display of the base game content.

11. The at least one non-transitory computer-readable storage medium of claim 10, wherein the instructions further cause the at least one processor to:
determine that the base amount stored in the third lookup table is stored as being associated with a plurality of trigger symbols, the plurality of trigger symbols comprising a first trigger symbol associated with the first feature content and a second trigger symbol associated with the second feature content; and
cause the plurality of credit amounts to be presented via display of at least the first feature content and the second feature content further based upon the base amount being stored in the third lookup table as being associated with the plurality of trigger symbols comprising the first trigger symbol and the second trigger symbol.

12. The at least one non-transitory computer-readable storage medium of claim 10, wherein the first feature content comprises wheel spin content, and wherein the second feature content comprises free spin content.

13. The at least one non-transitory computer-readable storage medium of claim 9, wherein the instructions further cause the at least one processor to determine the plurality of credit amounts based upon a plurality of bingo pattern pays associated with a bingo card and a ball call.

14. The at least one non-transitory computer-readable storage medium of claim 13, wherein the instructions further cause the at least one processor to receive one or messages from a bingo server, the one or more messages associated with at least one of the plurality of bingo pattern pays, the bingo card, or the ball call.

15. The at least one non-transitory computer-readable storage medium of claim 9, wherein the instructions further cause the at least one processor to sort the plurality of credits amounts from least to greatest.

16. The at least one non-transitory computer-readable storage medium of claim 15, wherein the instructions further cause the at least one processor to cause the plurality of credit amounts to be presented from least to greatest based upon the sorting.

17. A method of electronic gaming implemented by at least one processor in communication with at least one memory, the method comprising:
determining a plurality of credit amounts associated with a play of an electronic game;
performing a first lookup in a first lookup table of a plurality of lookup tables in the at least one memory to determine whether a greatest credit amount of the plurality of credit amounts corresponds to a first feature amount stored in the first lookup table, wherein the first lookup table is associated with first feature content;
performing a second lookup in a second lookup table of the plurality of lookup tables in the at least one memory to determine whether a subset of the plurality of credit amounts different from the greatest credit amount correspond to a number of second feature amounts stored in the second lookup table, wherein the second lookup table is associated with second feature content; and
based upon the greatest credit amount corresponding to the first feature amount stored in the first lookup table and the subset of the plurality of credit amounts different from the greatest credit amount corresponding to the number of second feature amounts stored in the second lookup table, causing the plurality of credit amounts to be presented via display of at least the first feature content and the second feature content.

18. The method of claim 17, further comprising:
performing a third lookup in a third lookup table of the plurality of lookup tables stored in the at least one memory to determine whether a lowest credit amount of the plurality of credit amounts corresponds to a base amount stored in the third lookup table, wherein the third lookup table is associated with base game content;
determining that the base amount stored in the third lookup table is stored as being associated with a plurality of trigger symbols, the plurality of trigger symbols comprising a first trigger symbol associated with the first feature content and a second trigger symbol associated with the second feature content;
based upon the lowest credit amount corresponding to the base amount, causing the plurality of credit amounts to further be presented via display of the base game content; and
causing the plurality of credit amounts to be presented via display of at least the first feature content and the second feature content further based upon the base amount being stored in the third lookup table as being associated with the plurality of trigger symbols comprising the first trigger symbol and the second trigger symbol, wherein the first feature content comprises wheel spin content, and wherein the second feature content comprises free spin content.

19. The method of claim 17, further comprising:
receiving one or messages from a bingo server, the one or more messages associated with at least one of a plurality of bingo pattern pays, a bingo card, or a ball call; and
determining the plurality of credit amounts based upon the plurality of bingo pattern pays associated with the bingo card and the ball call.

20. The method of claim 17, further comprising:
sorting the plurality of credits amounts from least to greatest; and
causing the plurality of credit amounts to be presented from least to greatest based upon the sorting.
